(19) United States
(12) Patent Application Publication
(10) Pub. No.: US 2006/0036947 A1
(43) Pub. Date: Feb. 16, 2006

(54) User interface controller method and apparatus for a handheld electronic device

(76) Inventors: Kevin W. Jelley, La Grange, IL (US); James E. Crenshaw, Palatine, IL (US); Michael Stephen Thiems, Elgin, IL (US)

Correspondence Address: MOTOROLA, INC., 1303 EAST ALGONQUIN ROAD, IL01/3RD, SCHAUMBURG, IL, 60196, US

(21) Appl. No.: 10/916,384

(22) Filed: Aug. 10, 2004

(51) Int. Cl. G11B 27/00

(52) U.S. Cl. 715/722

(57) ABSTRACT

A user interface controller of a handheld electronic device (100) that has a camera that generates video images presents (1105) information on a display (105) of the handheld electronic device, processes (1110) the video images to track at least one of a position and orientation of a directing object (260) that is within a field of view (225) of the camera, and modifies (1115) at least one scene presented on the display in response to a track of the directing object. Modification of scenes may include selecting one or more scene objects, moving a cursor object, and adjusting a viewing angle of successive scenes.

### FIELD OF THE INVENTION

This invention is generally in the area of handheld electronic devices, and more specifically in the area of human interaction with information presented on handheld electronic device displays.

### BACKGROUND

Small handheld electronic devices are becoming sufficiently sophisticated that the design of friendly interaction with them is challenging. In particular, the amount of information this is capable of being presented on the small, high density, full color displays that are used on many handheld electronic devices calls for a function similar to the mouse that is used on laptop and desktop computers to facilitate human interaction with the information on the display. One technique used to provide this interaction is a pointed object to touch the display surface to identify objects or areas showing on the display, but this is not easy to do under the variety of conditions in which small handheld devices, such as cellular telephones, are operated.

### BRIEF DESCRIPTION OF THE DRAWINGS

The present invention is illustrated by way of example and not limitation in the accompanying figures, in which like references indicate similar elements, and in which:

FIG. 1 is a functional block diagram that shows a handheld device in accordance with some embodiments of the present invention.

FIG. 2 is a perspective view that shows the handheld electronic device that includes a directing object and some virtual geometric lines, in accordance with some embodiments of the present invention.

FIG. 3 is a plan view that shows an image plane of a camera, in accordance with some embodiments of the present invention.

FIG. 4 is a cross sectional view that shows the handheld electronic device and the directing object, in accordance with some embodiments of the present invention.

FIG. 5 is a plan view that shows the image plane of the handheld electronic device that includes an object marker image, in accordance with some embodiments of the present invention.

FIG. 6 is a drawing of a directing object that may be used for both position and orientation, in accordance with some embodiments of the present invention.

FIG. 7 is a plan view of the display surface, in accordance with some embodiments of the present invention.

FIG. 8 is a plan of the display surface, in accordance with some embodiments of the present invention.

FIGS. 9, 10 and 11 are plan views of the display surface, in accordance with some embodiments of the present invention.

FIG. 12 shows a flow chart of some steps of a unique method that is used in the handheld device, in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular human interaction technique in accordance with the present invention, it should be observed that the present invention resides primarily in combinations of method steps and apparatus components related to human interaction with handheld electronic devices. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

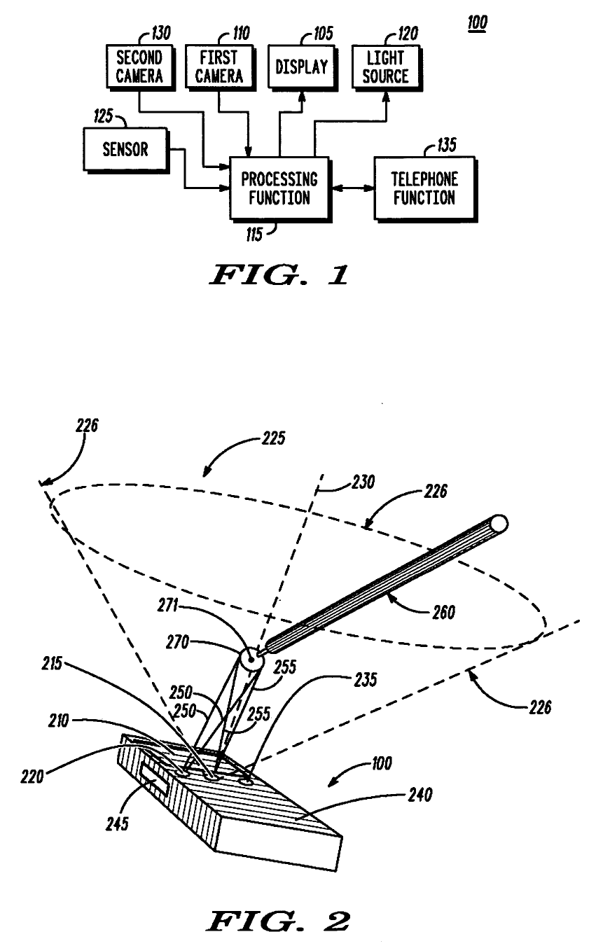

Referring to FIG. 1, a functional block diagram of a handheld electronic device 100 is shown, in accordance with some embodiments of the present invention. The handheld electronic device 100 comprises a display 105, a first camera 110, and a processing function 115 that is coupled to the display 105 and the first camera 110. The handheld electronic device 100 may further comprise a second camera 130, a light source 120, one or more sensors 125, and a telephone function 135, each of which (that are included) are also coupled to the processing function 115. The handheld electronic device 100 is uniquely comprised in accordance with the present invention as an apparatus that substantially improves human interaction with the handheld electronic device 100 in comparison to conventional devices, and a method for affecting such improvements that involves the handheld electronic device 100 is also described herein.

The handheld electronic device 100 is preferably designed to be able to be held in one hand while being used normally. Accordingly, the display 105 is typically small in comparison to displays of such electronic devices as laptop computers, desktop computers, and televisions designed for tabletop, wall, or self standing mounting. The handheld electronic device 100 may be a cellular telephone, in which case it will include the telephone function 135. In particular, when the handheld electronic device 100 is a cellular telephone, then in many cases, the display 105 will be on the order of 2 by 2 centimeters. Most electronic devices 100 for which the present invention is capable of providing meaningful benefits will have a display viewing area that is less than 100 square centimeters. The viewing surface of the display 105 may be flat or near flat, but alternative configurations could be used with the present invention. The technology of the display 105 may be any available technology compatible with handheld electronic devices, which for conventional displays includes, but is not limited to, liquid crystal, electroluminescent, light emitting diodes, and organic light emitting devices. The display 100 may include electronic circuits beyond the driving circuits that for practical purposes must be collocated with a display panel; for example, circuits may be included that can receive a video signal from the processing function 115 and convert the video signal to electronic signals needed for the display driving circuits. Such circuits may, for example, include a microprocessor, associated program instructions, and related processing circuits, or may be an application specific circuit.

The cellular telephone function 135 may provide one or more cellular telephone services of any available type. Some conventional technologies are time division multiple access (TDMA), code division multiple access (CDMA), or analog, implemented according to standards such as GSM, CDMA 2000, GPRS, etc. The telephone function 135 includes the necessary radio transmitter(s) and receiver(s), as well as processing to operate the radio transmitter(s) and receiver(s), encode and decode speech as needed, a microphone, and may include a keypad and keypad sensing functions needed for a telephone. The telephone function 135 thus includes, in most examples, processing circuits that may include a microprocessor, associated program instructions, and related circuits.

The handheld electronic device 100 may be powered by one or more batteries, and may have associated power conversion and regulation functions. However, the handheld electronic device 100 could alternatively be mains powered and still reap the benefits of the present invention.

The first camera 110 is similar to cameras that are currently available in cellular telephones. It may differ somewhat in the characteristics of the lens optics that are provided, because the present invention may not benefit greatly from a depth of field range that is greater than approximately 10 centimeters (for example, from 5 centimeters to 15 centimeters) in some embodiments that may be classified as two dimensional. In some embodiments that may include those classified as two dimensional, as well as some embodiments classified as three dimensional, the first camera 110 may benefit from a depth of field that is very short—that is, near zero centimeters, and may not provide substantially improved benefits by being more than approximately 50 centimeters. In one example, the present invention may provide substantial benefits with a depth of field that has a range from about 5 centimeters to about 25 centimeters. These values are preferably achieved under the ambient light conditions that are normal for the handheld device, which may include near total darkness, bright sunlight, and ambient light conditions in between those. Means of achieved the desired depth of field are provided in some embodiments of the present invention, as described in more detail below. A monochrome camera may be very adequate for some embodiments of the present invention, while a color camera may be desirable in others.

The processing function 115 may comprise a microprocessor, associated program instructions stored in a suitable memory, and associated circuits such as memory management and input/output circuits. It may possible that the processing function 115 circuits are in two or more integrated circuits, or all in one integrated circuit, or in one integrated circuit along with other functions of the handheld electronic device 100.

Referring to FIG. 2, a perspective view of the handheld electronic device 100 is shown that includes a directing object 260 and some virtual geometric lines, in accordance with some embodiments of the present invention. Shown in this view of the handheld electronic device 100 are a viewing surface 210 of the display, a camera aperture 215, a light source aperture 220, a sensor aperture 235, a sensor that is a switch 245, and a keypad area 240. The first camera 110 has a field of view 225 that in this example is cone shaped, as indicated by the dotted lines 226, having an axis 230 of the field of view. The axis 230 of the field of view is essentially perpendicular to the surface 210 of the display. (The display viewing surface is assumed to be essentially parallel to the surface of the handheld electronic device 100.) For typical displays 105, which are planar in their construction, the axis may be said to be oriented essentially perpendicular to the display 105. The camera aperture 215 may include a camera lens.

The directing object 260 may also be described as a wand, which in the particular embodiment illustrated in FIG. 2 includes a sphere 270 mounted on one end of a handle. The directing object 260 may be held by a hand (not shown in FIG. 2). The sphere 270 has a surface that may produce an image 370 (FIG. 3) on an image plane 301 (FIG. 3) of the first camera 110, via light that projects 255 from the surface of the sphere 270. The surface of the sphere is called herein the directing object marker, and in other embodiments there may be a plurality of directing object markers. The light projecting 255 onto the image plane 301 may be, for example, ambient light that is reflected from the surface of the sphere 270, light that is emitted from the light source 120 and reflected from the surface of the sphere 270, or light that is generated within the sphere 270 which is transmitted through a transparent or translucent surface of the sphere, or light that is generated at the surface of the sphere 270. An image 360 of the surface of the other part (a handle) of the directing object 260 (which is not a directing object marker in this example) may also be projected on the image plane 301 by reflected light. In some embodiments, the object marker may cover the entire directing object.

Referring to FIG. 3, a plan view is shown of an image plane 301 of the first camera 110, in accordance with some embodiments of the present invention. The image plane 301 may be the active surface of an imaging device, for example a scanned matrix of photocells, used to capture the video images. In the example shown in FIG. 3, the active surface of the imaging device has a periphery 302, which corresponds approximately to the limits of the field of view of the first camera 110. The image 370 of the sphere 270 produced on the image plane 301 is called the image of the object marker (or object marker image). The directing object 260 may be implemented in alternative embodiments that generate alternative object marker, as will be further detailed below. In alternative embodiments of the present invention more than one object marker may be provided on the directing object. In many of the embodiments, the directing object is designed to be comfortably held and moved over the handheld electronic device 100 by one hand while the handheld electronic device 100 is held in the other hand. The first camera 110 generates a succession of video images by techniques that may include those that are well known to one of ordinary skill in the art. The object marker image 370 may appear at different positions and orientations within successive video images, in response to movement of the directing object 260 relative to the handheld electronic device 100. It will be appreciated that in general, the object marker image is not simply a scaled version of a two dimensional view of the directing object (in which the plane of the two dimensional view perpendicular to the axis of the field of view), because the object marker image is cast onto the image plane through a conventional lens which produces an image that is distorted with reference to a scaled version of a two dimensional view of the directing object. Thus, the object marker image in this example is not a circle, but more like an ellipse.

The processing function 115 uniquely includes a first function that performs object recognition of the object marker image 370 using techniques that may include well known conventional techniques, such as edge recognition, and a second function that determines at least a two dimensional position of a reference point 271 (FIG. 2) of the directing object 360, using techniques that may include well known conventional techniques. In one embodiment, the two dimensional position of the reference point 271 is defined as the position of the projection of the reference point 271 on the image plane 301, using a co-ordinate system that is a set of orthogonal rectangular axes 305, 310 having an origin in the image plane at the point where the image plane is intersected by the axis 230 of the field of view 225. Although this does not identify the two dimensional position of the reference point 271 itself within a three dimensional rectangular coordinate system having the same origin, defining the position of the projection of the object marker(s) in this manner may be suitable for many uses of the present invention. In the example illustrated, the first function recognizes the object marker image 370 as a circle somewhat modified by the projection, and the second function determines the two dimensional position of the center of the object marker image 370 within the orthogonal coordinate system 305, 310 of the image plane 301. In some embodiments, the object marker image may be sufficiently close to a circle that it recognized using equations for a circle. In other embodiments described herein, the first function of the processing function 115 identifies an image of an object marker that is more complicated than projected sphere, and the second function of the processing function 115 determines a three dimensional position and an orientation of a directing object. A third function of the processing function 115 maintains a history of the position (or orientation, when determined by the second function, or both) of the directing object 260 obtained from at least some of the successive video images generated by the first camera 110. The first, second, and third functions of the processing function 115 are encompassed herein by the term “tracking a directing object that is within a field of view of the first camera”, and the “track of the directing object” constitutes in general a history of the position and orientation of the directing object over a time period that may be many seconds, but may in some circumstances constitute a subset of the more general definition of “the track of a directing object”, such as simply a current position of the directing object.

As will be described in more detail below, the processing function performs a further function of modifying a scene that is displayed on the display 105 in response to the track of the directing object 260 in the coordinate system used for. Related to this aspect is a mapping of the directing object's track from the coordinate system used for the tracking of the directing object to the display 105, which is depicted in FIG. 3 as square 320. It will be appreciated that the mapping of the directing objects' track to the display 105 may be more complicated than a simple relationship that might be inferred in FIG. 3, wherein if the display is square, then the relationship of the coordinates for the directing object's track as defined in a coordinate system related to the first camera 110 and display might be a single scaling value. It is easy to see that if the display is rectangular, then the display could be mapped as the square shown, by using different scaling values in the x and y directions. Other mappings could also be used. For example a rectangular display could be mapped using a common scaling factor in the x and y directions; in which case the distances moved by the directing object 260 that correspond to the x and y axes of the display would be different.

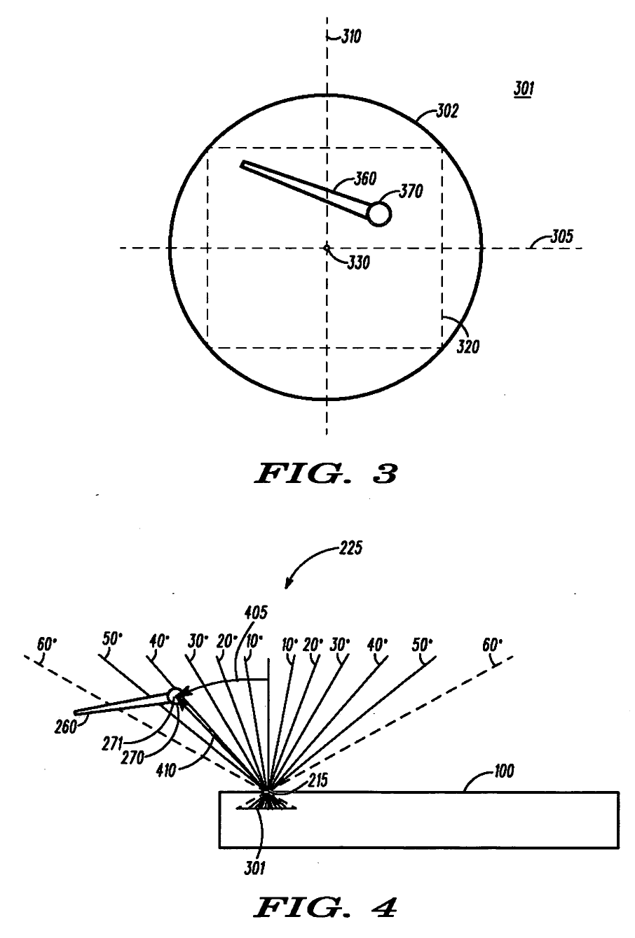

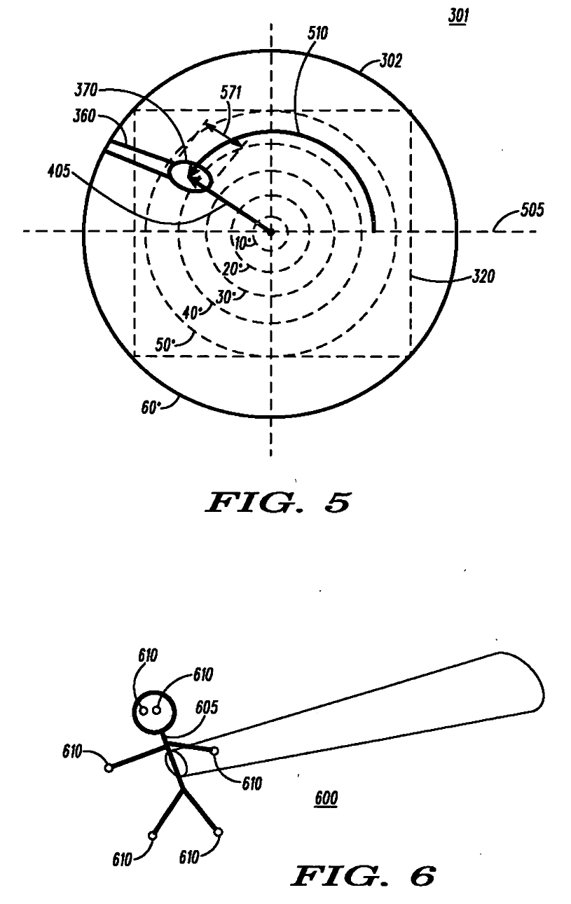

Referring to FIG. 4, a cross sectional view of the handheld electronic device 100 and the directing object 260 is shown, in accordance with some embodiments of the present invention. Referring to FIG. 5, a plan view of the image plane 301 of the handheld electronic device 100 is shown that includes the object marker image 370 produced by the surface of the sphere when the directing object 260 is in the position relative to the handheld electronic device 100 as illustrated in FIG. 4. The directing object 260 is not necessarily in the same position relative to the handheld electronic device 100 as shown in FIGS. 2 or 3. Also illustrated in FIGS. 4 and 5 is a three dimensional coordinate system having an origin at a center of projection of a lens in the first camera aperture 215. The position of the directing object 260, which is the position of the center of the sphere 270, is defined in three dimensions in this example using three dimensional co-ordinates, which are identified as Phi (φ) 405, Theta (θ) 510, and R 410. Theta is an angle of rotation in the image plane 301 about the axis 230 of the field of view 225 with reference to a reference line 505 in the image plane 301. Phi is an angle of inclination from the axis 230 of the field of view 225, and R is the distance from the origin to the position of the directing object 260 (reference point 271). In FIG. 5, the projection of the loci of all positions having a constant value of φ (e.g., 30°) is a circle. It will be appreciated that the size of the object marker image 370, increases as the distance, R, to the sphere 270 is reduced, but also that the image of the sphere 270 is changed from a circle when φ is zero degrees to an elliptical shape that becomes more elongated as φ increases. R can be determined from a measurement of a dimension of the elliptical image of the sphere 270, such as the major axis 371 of the ellipse, and from the angle φ. The angle φ can be determined by the distance on the image plane 301 of the center of the major axis 371 from the intersection of the axis 230 with the image plane 301. Thus, a three dimensional position of the directing object 360 is determined. However, it will be further appreciated from the descriptions given with reference to FIGS. 3-5 that the orientation of the directing object 360 may not be determined by the measurements described.

A determination of the position and orientation of a directing object in a three dimensional coordinate system by using a camera image can be made from 6 uniquely identifiable points positioned on the directing object. However, it will also be appreciated that simpler methods can often provide desired position and orientation information. For example, it may be quite satisfactory to determine only an orientation of the handle of the directing object 360 described with reference to FIGS. 3-5 (i.e., not resolving an amount of roll around the axis of the handle). Also, some theoretical ambiguity may be acceptable, such as assuming in the above example that the handle is always pointing away from the camera. For some uses, only a three dimensional position and no orientation may be needed, while in others, only a two dimensional position without orientation may be needed.

There are a variety of techniques that may be used to assist the identification of the directing object by the processing function 115. Generally speaking, an object of such means is to improve a brightness contrast ratio and edge sharpness between of the images of certain points or areas of the directing object 360 with reference to the images that surround those points or areas, and make the determination of defined point locations computationally simple. In the case of the wand example described above, the use of a sphere projects a circular, or nearly circular, image essentially regardless of the orientation of the wand (as long as the thickness of the handle is small in comparison to the diameter of the sphere 270), with a defined point location at the center of the sphere. The sphere 270 may be coated with a highly diffuse reflective white coating, to provide a high brightness contrast ratio when operated in a variety of ambient conditions. For operation under perhaps more ambient conditions, the sphere 270 may be coated with a retro-reflective coating and the handheld electronic device 100 may be equipped with a light source 120 having an aperture 220 located close to the first camera aperture 215. The sphere 270 may be a light source. In some embodiments, the image processing function may be responsive to only one band of light for the object marker image (e.g., blue), which may be produced by a light source in the object marker(s) or may selectively reflected by the object marker(s). The use of directing object markers that are small in size in relation to the field of view at normal distances from the first camera 110 may be particularly advantageous when there are multiple directing object markers. The directing object may take any shape that is compatible with use within a short range (as described above) of the handheld electronic device 100 and appropriate for the amount of tracking information that is needed. For example, the wand described herein above may be most suitable for two dimensional and three dimensional position information without orientation information. Directing object markers added to the handle of the wand (e. g., a couple of retro-reflective bands) may allow for limited orientation determinations that are quite satisfactory in many situations. In a situation where full orientation and three dimensional positions are needed, the directing object may need to have one or more directing object markers sufficiently spaced so that six are uniquely identifiable in all orientations of the directing object during normal use. In general, the parameters that the image processing function uses to identify the images of the directing object markers and track the directing object include those known for object detection, and may include such image detection parameters as edge detection, contrast detection, shape detection, etc., each of which may have threshold and gain settings that are used to enhance the object detection. Once the images of the directing object markers have been identified, first set of formulas may be used to determine the position of the directing object (i.e., the position of a defined point that is fixed with reference to the body of the directing object), and a second set of formulas may be used to determine the orientation. More typically, the first and second formulas are formulas that convert such intermediate values as slopes and ends of edges to a marker position and orientation in a chosen coordinate system.

For the purpose of keeping complexity of the processing function 115 down, it is desirable to use reflective directing object markers. This provides the advantage of making the directing object markers appear brighter than other objects in the image. If this relative brightness can be increased sufficiently, then the shutter speed can be increased to the point where almost no other objects are detected by the camera. When the number of undesired objects in the image is reduced, a much simpler algorithm may be used to identify the directing object markers within the image. Such a reduction in complexity translates into reduced power consumption, because fewer results must be calculated. Such a reduction in complexity also reduces processing function cost since memory requirements may be reduced, and fewer special processing accelerators, or a slower, smaller processor core can be selected. In particular, the reflective material may be retro-reflective, which is highly efficient at reflecting light directly back toward the light source, rather than the more familiar specular reflector, in which light rays incident at angle a are reflected at angle 90-α (for instance in a mirror), or Lambertian reflectors, which reflect light in a uniform distribution over all angles. When retro-reflectors are used, it is necessary to include a light source 120 such as an LED very close to the camera lens 215 so that the lens 215 is in the cone of light reflected back toward the illuminant by the retro-reflective directing object markers. One embodiment of a directing object that may provide determination of three dimensional positions and most normal orientations is shown in FIG. 6, which is a drawing of a wand 600 that has a stick FIG. 605 on one end. The stick FIG. 605 provides a natural indication to the user of the orientation of the directing object, and includes a plurality of retroreflectors 610. (Alternatively, the retroreflectors 610 could be replaced by light emitting components, which may use different colors to simplify identification of the directing object markers, but which would add complexity to the wand compared to retroreflectors, and which may not work as well in all ambient lighting conditions).

In other embodiments, the axis of the field of view may be directed away from being perpendicular to the display. For example, the axis of the field of view may be directed so that it is typically to the right of perpendicular when the handheld electronic equipment is held in a user's left hand. This may improve edge detection and contrast ration of image markers that may otherwise have a user's face in the background, due to a longer range to objects in the background of the directing object other than the user's face. This biasing of the axis of field of view away from the user's face may require a left hand version and a right hand version of the handheld electronic device, so an alternative is to provide a first camera 110 that can be manually shifted to improve the probability of accurate image detection under a variety of circumstances.

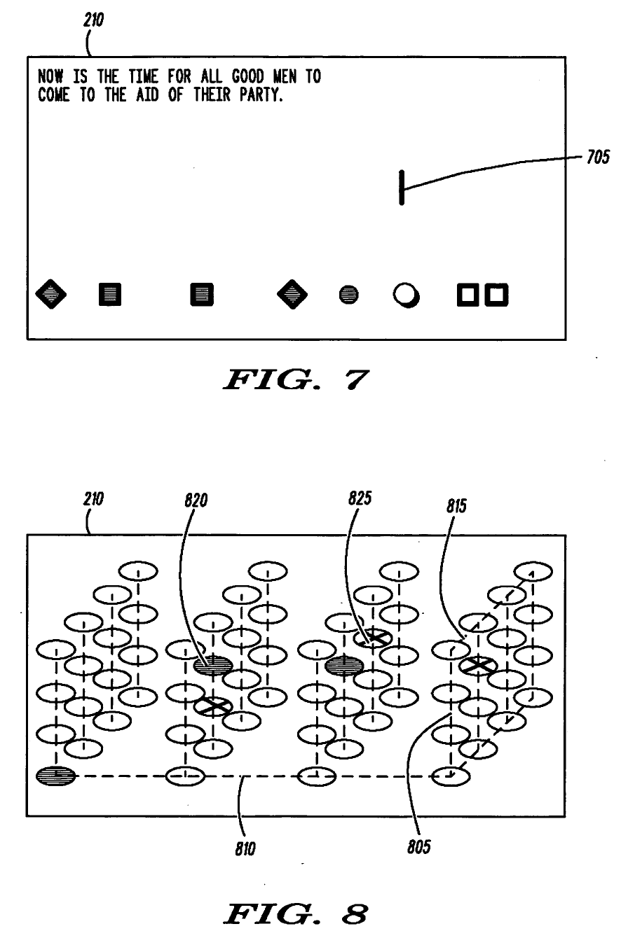

Referring now to FIG. 7, a plan view of the display surface 210 is shown, in accordance with some embodiments of the present invention. This view shows a scene that comprises characters and icons. The term scene is used herein to mean one set of information shown on the display amongst many that may vary over time. E. g., a text screen such as that shown may change by having a character added, changed or deleted, or by having an icon change to another icon, for example. For other uses, the scene may be one frame of a video image that is being presented on the display 105. As described above, the track of the object is used by the processing function to modify a scene on the display 105. Such modifications include, but are not limited to moving a cursor object within one or more successive scenes on the display, selecting one or more scene objects within one or more successive scenes on the display, and adjusting a viewing perspective of successive scenes on the display. The cursor object 705 may be appear similar to an text insertion marker as shown in FIG. 7, but may alternatively may any icon, including, but not limited to, such familiar cursor icons as a hourglass or plus sign, or an arrow, which may or may not be blinking or have another type of changing appearance. The cursor object 705 may be moved in response to the position of the directing object in two dimensions, and may be used in conjunction with other commands to perform familiar cursor functions such as selecting one or more of the characters or icons. The commands may be any command for impacting the motion, use, or appearance of the cursor object, including, but not limited to, those associated with mouse buttons, such as left click, right click, etc. The commands may be entered using any input sensor for a handheld device, such as one or more push or slide switches, rotary dials, keypad switches, a microphone coupled with a command recognition function, and a touch sensor in the display surface 210 or elsewhere. The command sensing technique may be a detection of a unique track of the directing object 360 in the video image by the image processing function that is reserved for a command in a particular application, such as a very fast movement of the directing object away from the display 105. The command sensing technique may involve the detection of a unique pattern of directing object markers. For example an object marker that is normally not energized may emit light in response to an action on the part of the user, such as pressing a button on the directing object. An alternative or additional technique is to change the color or brightness of an object marker in response to a user's hand action

The command may initiate a drawing function that draws a scene object in response to motions of the cursor that are in response to movement of the directing object. Such drawing may of any type, such as a creation of a new picture, or in the form of overlaying freeform lines on a scene obtained from another source. As one example, a user of another computing device may send a picture to the handheld device 100 and the user of the handheld device may identify a first scene object (e.g., a picture of a person in a group of people) by invoking a draw command and drawing a second scene object on top of the scene by circling the first scene object using the directing object. The user of the handheld device 100 may then return the marked up picture to the computing device (e.g., by cellular messaging) for presentation to the user of the computing device.

While examples of two-dimensional position tracking have been described above, two dimensional position and orientation tracking may also by useful, as for a simple game of billiards that is presented only as a plan view of the table and queue sticks.

Referring to FIG. 8, a plan of the display surface 210 is shown, in accordance with some embodiments of the present invention. The display 105 is presenting a perspective scene of a three dimensional tic-tac-toe game as an example of a situation in which a detection of a three dimensional position of the sphere 270 might be used advantageously to control the insertion of a next “playing piece” (Three playing pieces 820 of a first player and three playing pieces 825 of a second player are shown in FIG. 8) In this fixed perspective of a three dimensional rendering (within in the two dimensions of the display surface 210), the movement of the directing object away from and towards the surface of the display 105 may be used to adjust a selection of a position for a next playing piece along the axis 815 that may be considered to be in and out of the plane of the display surface 210, whereas the movement of the directing object parallel to the surface of the display 105 may be used to adjust a selection of a position for a next playing piece along the axes 805, 810. Many other alternative uses of a three dimensional position tracking of the directing object are possible.

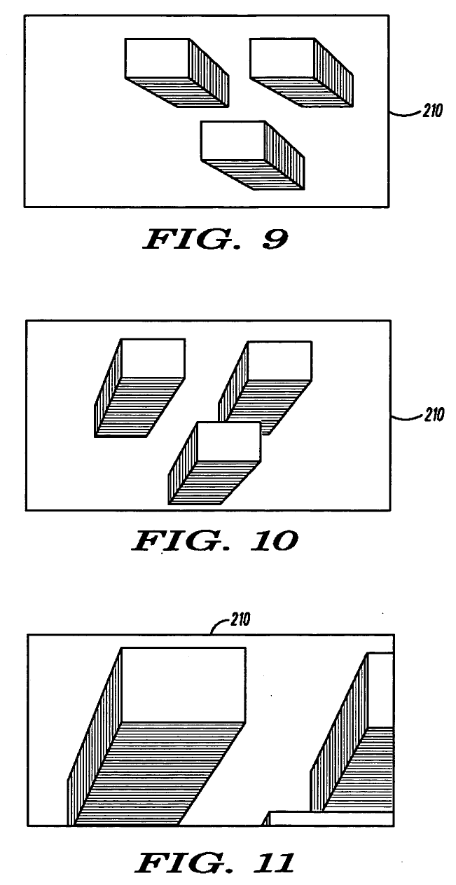

Referring to FIGS. 9, 10 and 11, plan views of the display surface 210 are shown, in accordance with some embodiments of the present invention. The display 105 is presenting a perspective scene of a portion of a downtown area in a game, as an example as an example of a situation in which a detection of a three dimensional position and orientation of a directing object might be used advantageously to control the view of the downtown area during one mode of control provided in this game. In this alterable perspective of a three dimensional rendering, a change in orientation of the directing object without a change in distance to the display surface 210 may cause a change of scene as depicted by FIGS. 8 and 9, while a movement of the directing object towards the surface of the display 105 without a change in orientation may cause a change of perspective as depicted by FIGS. 9 and 10. When a user has adjusted the viewing perspective of the successive scenes that are necessary to present the changing perspective, to a desired perspective, the user may then change the mode of the directing object's control over the scene on the display 105 to one which allows movement of a cursor in three dimensions (“up and down” within the blocks that represent the buildings, or “horizontally” between buildings and on “floors” within the buildings). Orientation and position tracking of the directing object may be useful for this cursor movement, or response only positional tracking may be appropriate. Many other alternative uses of a three dimensional position and orientation tracking of the directing object are possible.

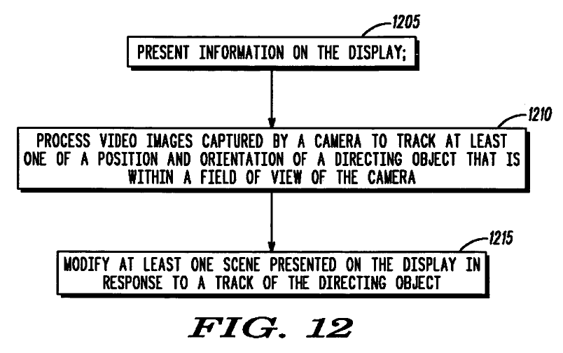

Referring to FIG. 12, steps of a unique method used in the handheld device 100 are shown, in accordance with some embodiments of the present invention. At step 1205, information is presented on the display 105. Video images captured by a camera are processed at step 1210 to track at least one of a position and orientation of a directing object that is within a field of view of the camera. At step 1215, at least one scene presented on the display is modified in response to a track of the directing object.

It will be appreciated that a scene presented on the display 105 may be one that has been stored in, or generated from memory, or received by the handheld device 105. In some embodiments, the handheld device 105 may have a second built in camera, as is well known today, for capturing still or video images, or the first camera may be used for capturing a still or video image that is presented as a scene on the display for modification using the directing object.

It will be appreciated the processing function 115 and portions of one or more of the other functions of the handheld electronic device, including functions 105, 110, 120, 125, 130, 135 may comprise one or more conventional processors and corresponding unique stored program instructions that control the one or more processors to implement some or all of the functions described herein; as such, the processing function 115 and portions of the other function 105, 110, 120, 125, 130, 135 may be interpreted as steps of a method to perform the functions. Alternatively, these functions 115 and portions of functions 105, 110, 120, 125, 130, 135 could be implemented by a state machine that has no stored program instructions, in which each function or some combinations of portions of certain of the functions 115, 105, 110, 120, 125, 130, 135 are implemented as custom logic. Of course, a combination of the two approaches could be used. Thus, both a method and apparatus for a handheld electronic device has been described herein.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

A “set” as used herein, means a non-empty set (i.e., for the sets defined herein, comprising at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A user interface controller of a handheld electronic device, comprising:
a display,
a first camera that generates video images; and
a processing function coupled to the display and the first camera, that
presents information on the display,
processes the video images to track at least one of a position and an orientation of a directing object that is within a field of view of the first camera, and
modifies at least one scene presented on the display in response to a track of the directing object.

2. The user interface controller of a handheld electronic device according to claim 1, wherein the processing function that modifies the at least one scene, performs at least one of the functions of
moving a cursor object within one or more successive scenes on the display in response to a track of the directing object;
selecting one or more scene objects within one or more successive scenes on the display in response to a track of the directing object; and
adjusting a viewing perspective of successive scenes on the display in response to a track of the directing object.

3. The user interface controller of a handheld electronic device according to claim 2, wherein for the function of selecting, the one or more scene objects are one of characters and icons.

4. The user interface controller of a handheld electronic device according to claim 2, wherein for the function of moving a cursor object, a response to the motion of the cursor object after the processor interprets a drawing command is drawing a scene object within the one or more successive scenes according to the motion of the cursor.

5. The user interface controller of a handheld electronic device according to claim 2, wherein for the function of moving a cursor object, the cursor object is an icon.

6. The user interface controller of a handheld electronic device according to claim 2, wherein the moving of a cursor object comprises modifying the cursor object in response to a three dimensional tracking of the directing object.

7. The user interface controller of a handheld electronic device according to claim 2, wherein the adjusting of a viewing perspective of successive scenes comprises modifying a three dimensional aspect of the successive scenes in response to a three dimensional tracking of the directing object.

8. The user interface controller of a handheld electronic device according to claim 2, wherein the
moving of the cursor object within one or more successive scenes on the display is performed in response to one or more positions and one or more orientations of the directing object, and includes modifications of the cursor object, and
adjusting of the viewing perspective of successive scenes on the display is performed in response to one or more positions and one or more orientations of the directing object.

9. The user interface controller of a handheld electronic device according to claim 8, further comprising at least one sensor by which the processor detects at least one user command that impacts the one of the functions of selecting, moving and adjusting.

10. The user interface controller of a handheld electronic device according to claim 9, wherein the at least one sensor comprises a touch sensitive detector.

11. The user interface controller of a handheld electronic device according to claim 9, wherein the at least one sensor is a microphone responsive to voice, and wherein the at least one user command is interpreted by a speech recognition function coupled to the sensor.

12. The user interface controller of a handheld electronic device according to claim 9, wherein the sensor is the first camera and wherein the at least one user command is detected in response to at least one particular track of the directing object.

13. The user interface controller of a handheld electronic device according to claim 9, wherein the at least one sensor is the first camera and wherein the at least one command is detected in response to a particular pattern within the video image.

14. The user interface controller of a handheld electronic device according to claim 1, wherein the display has a viewing area that is less than 100 square centimeters.

15. The user interface controller of a handheld electronic device according to claim 1, wherein the first camera has a depth of field range of at least 10 centimeters under lighting conditions expected for normal use.

16. The user interface controller of a handheld electronic device according to claim 1, wherein an axis of the field of view of the first camera is oriented in a direction essentially perpendicular to the display.

17. The user interface controller of a handheld electronic device according to claim 1, wherein an axis of the field of view is oriented in a direction biased away from an expected direction of an operator's face.

18. The user interface controller of a handheld electronic device according to claim 1, wherein an axis of the field of view of the first camera can be moved by an operator of the electronic device.

19. The user interface controller of a handheld electronic device according to claim 1, wherein the processing function that processes the video images to track the position of the directing object is responsive to images of one or more directing object markers that have one or more of the group of characteristics comprising:
each object marker image is a projection of a defined shape that includes at least one defined point location,
each object marker image is small in size in relation to the field of view,
each object marker image has a high brightness contrast ratio compared to the immediate surroundings, and
each object marker image primarily comprises light in a particular light band.

20. The user interface controller of a handheld electronic device according to claim 1, wherein the processing function tracks the directing object using at least one image of one or more directing object markers.

21. The user interface controller of a handheld electronic device according to claim 20, wherein the handheld electronic device further comprises a light source and the image of at least one of the one or more directing object markers is a reflection of light from a light source in the handheld electronic device.

22. The user interface controller of a handheld electronic device according to claim 21, wherein at least one of the one or more directing object markers comprises a retro-reflector that causes the reflection of light.

23. The user interface controller of a handheld electronic device according to claim 20, wherein at least one of the one or more directing object markers comprises a light source that generates the image of the one of the one or more directing object markers.

24. The user interface controller of a handheld electronic device according to claim 1, wherein the processing function tracks the directing object in two dimensions that are in the plane of the display.

25. The user interface controller of a handheld electronic device according to claim 1, wherein the processing function tracks the directing object in three dimensions.

26. The user interface controller of a handheld electronic device according to claim 1, wherein the processing function further processes the video images to track a position of the directing object and determines the position of the directing object from images of one or more directing object markers on the directing object.

27. The user interface controller of a handheld electronic device according to claim 26, wherein the processing function further processes the video images to track an orientation of the directing object and determines the orientation of the directing object from the images of one or more directing object markers that are on the directing object.

28. The user interface controller of a handheld electronic device according to claim 1, wherein the processing function further performs a function that transmits information related to at least a portion of a scene on the display to a communication device.

29. The user interface controller of a handheld electronic device according to claim 1, further comprising a second camera, wherein the information on the display comprises images captured by the second camera.

30. The user interface controller of a handheld electronic device according to claim 1, wherein the handheld electronic device further comprises a wireless telephone.

31. A user interface method used in a handheld electronic device that has a camera that generates video images and has a display, comprising:
presenting information on the display;
processing the video images to track at least one of a position and orientation of a directing object that is within a field of view of the camera; and
modifying at least one scene presented on the display in response to a track of the directing object.

32. The user interface method according to claim 30, wherein the modifying further comprises at least one of:
selecting one or more scene objects within one or more successive scenes on the display in response to a track of the directing object,
moving a cursor object within one or more successive scenes on the display in response to a track of the directing object, and
adjusting a viewing angle of successive scenes on the display in response to a track of the directing object.

33. The user interface method according to claim 32, wherein the processing function tracks the directing object using images of one or more directing object markers.
